(19) United States
(12) Patent Application Publication
(10) Pub. No.: US 2011/0263270 A1
(43) Pub. Date: Oct. 27, 2011

(54) METHOD AND SYSTEM FOR SHARING A SIGNAL RECEIVED BY AN ANTENNA

(75) Inventors: Iain Campbell ROY, Mississauga (CA); Michael Huu Duc TRAN, Mississauga (CA)

(73) Assignee: PSION TEKLOGIX INC., Mississauga (CA)

(21) Appl. No.: 12/766,237

(22) Filed: Apr. 23, 2010

(51) Int. Cl. H04W 64/00

(52) U.S. Cl. 455/456.1

(57) ABSTRACT

Described are a method, system, and mobile communication device for sharing a signal received by an antenna. A signal, such as a signal sent from a global positioning system, is received by the antenna. An amplifier is then used to generate an amplified signal. The amplifier is located an attenuation distance away from a noise source. The amplified signal is divided into a first divided signal and a second divided signal, which are respectively transmitted to first and second signal utilization modules. While being transmitted from the antenna to the first and second signal utilization modules, the signal suffers propagation losses. While locating the amplifier remote from the noise source decreases noise strength, which positively contributes to signal-to-noise ratio, it also increases propagation losses, which negatively contributes to signal-to-noise ratio. The method, system and mobile communication device are designed such that this positive contribution exceeds this negative contribution, resulting in an overall benefit to signal-to-noise ratio. Also beneficially, sharing the signal allows one antenna to be used for both signal utilization modules, lowering manufacturing costs and saving space in the mobile communication device.

### FIELD OF THE INVENTION

The present disclosure is directed at a method and system for sharing a signal received by an antenna. More particularly, the present disclosure is directed at a method and system for sharing a signal sent by a global positioning system that is received by the antenna.

### BACKGROUND OF THE INVENTION

Space is a precious commodity when designing mobile communication devices. As mobile communication devices need to be portable, it is generally advantageous to design them to be relatively small and light such that they can be conveniently transported to and used at different locations. Cost is also an issue when designing mobile communication devices. The less expensive a mobile communication device is, the more likely it is that consumers will purchase and use it. Another issue that arises when designing mobile communication devices is maintaining an adequate signal-to-noise ratio during signal processing. Mobile communication devices utilize a large number of electronic components that each generate electromagnetic interference (noise), which makes maintaining an adequate signal-to-noise ratio during signal processing challenging.

Accordingly, there exists a need to design mobile communication devices in an inexpensive, space efficient manner such that an adequate signal-to-noise ratio is maintained during signal processing.

### SUMMARY OF THE INVENTION

According to a first aspect, there is provided a system for sharing a signal received by an antenna. The system includes an amplifier communicatively coupled to the antenna to receive the signal and configured to output an amplified signal. The amplifier is disposed an attenuation distance away from a noise source wherein the attenuation distance is inversely proportional to noise strength as measured at the amplifier. The system also includes a signal divider communicatively coupled to the amplifier to receive the amplified signal and configured to divide the amplified signal into a first divided signal and a second divided signal; a first signal utilization module communicatively coupled to the signal divider to receive the first divided signal and communicatively coupled to the amplifier via the signal divider along a first signal propagation path having a length directly proportional to first divided signal propagation losses; and a second signal utilization module communicatively coupled to the signal divider to receive the second divided signal. The attenuation distance and the length of the first signal propagation path are selected such that a positive contribution to a signal-to-noise ratio as measured at the first signal utilization module resulting from attenuation of noise exceeds a negative contribution to the signal-to-noise ratio resulting from the first divided signal propagation losses.

The second signal utilization module may also be communicatively coupled to the amplifier via the signal divider along a second signal propagation path having a length directly proportional to second divided signal propagation losses. If so coupled, the attenuation distance and the length of the second signal propagation path can be selected such that a positive contribution to a signal-to-noise ratio as measured at the second signal utilization module resulting from attenuation of noise exceeds a negative contribution to the signal-to-noise ratio resulting from the second divided signal propagation losses.

The signal may be sent by a global positioning system (GPS) and one of the first and second signal utilization modules may be a dedicated GPS module. The other of the first and second signal utilization modules may be a WAN radio module communicatively coupled to a WAN antenna and the WAN radio module may transmit a WAN radio signal that includes location data obtained from the signal sent by the GPS.

A power source may be electrically coupled to a bias tee in order to supply power to the amplifier. The bias tee can be communicatively coupled between the signal divider and the amplifier such that the power source supplies power to the amplifier.

The antenna may be a patch antenna disposed on a printed circuit board. The patch antenna may be a rectangular antenna trace having two ends, two parasitic reflectors, and two gaps, and each of the ends of the antenna trace can be spaced from one of the parasitic reflectors by one of the gaps.

Alternatively, the antenna may be a fractal antenna disposed on a printed circuit board having an antenna trace electrically coupled to an adjacent ground plane. The ground plane may have one or more pigtails extending therefrom. The ground plane may be substantially rectangular and have two opposed side edges disposed between two opposed end edges, wherein a first pigtail extends from a first end of one of the end edges and a second pigtail extends from a second end of the one of the end edges, and wherein the first and second pigtails are of different lengths.

According to a second aspect, there is provided a mobile communication device. The mobile communication device includes a main body and an endcap detachably coupled to one end of the main body. Contained within the endcap are an antenna configured to receive a signal; and an amplifier communicatively coupled to the antenna to receive the signal and to output an amplified signal. Contained within the main body are a processor; a memory communicatively coupled to the processor and having statements and instructions encoded thereon for execution by the processor to configure the mobile communication device to communicate wirelessly; a signal divider communicatively coupled to the amplifier to receive the amplified signal and configured to divide the amplified signal into a first divided signal and a second divided signal; and first and second signal utilization modules each communicatively coupled to the processor wherein the first signal utilization module is also communicatively coupled to the signal divider to receive the first divided signal and the second signal utilization module is also communicatively coupled to the signal divider to receive the second divided signal.

The signal may be sent by a GPS and one of the first and second signal utilization modules may be a dedicated GPS module. A WAN antenna may be disposed in the endcap and the other of the first and second signal utilization modules may be a WAN radio module communicatively coupled to the WAN antenna. The WAN radio module may transmit a WAN radio signal that includes location data obtained from the signal sent by the GPS.

Also disposed within the main body may be a power source that is electrically coupled to a bias tee in order to supply power to the amplifier. The bias tee can be communicatively coupled between the signal divider and the amplifier such that the power source supplies power to the amplifier.

The antenna may be a patch antenna disposed on a printed circuit board. The patch antenna may be a rectangular antenna trace having two ends, two parasitic reflectors, and two gaps, and each of the ends of the antenna trace may be spaced from one of the parasitic reflectors by one of the gaps.

Alternatively, the antenna may be a fractal antenna disposed on a printed circuit board having an antenna trace electrically coupled to an adjacent ground plane. The ground plane may have one or more pigtails extending therefrom. The ground plane may be substantially rectangular and have two opposed side edges disposed between two opposed end edges, wherein a first pigtail extends from a first end of one of the end edges and a second pigtail extends from a second end of the one of the end edges, and wherein the first and second pigtails are of different lengths.

According to a third aspect, there is provided a method for sharing a signal received by an antenna. The method includes receiving the signal from the antenna; generating an amplified signal by amplifying the signal with an amplifier, wherein the amplifier is disposed an attenuation distance away from a noise source and wherein the attenuation distance is inversely proportional to noise strength as measured at the amplifier; dividing the amplified signal into a first divided signal and a second divided signal; and respectively transmitting the first and second divided signals to first and second signal utilization modules for utilization, the first signal utilization module communicatively coupled to the amplifier along a first signal propagation path having a length directly proportional to first divided signal propagation losses. The attenuation distance and the length of the first signal propagation path are selected such that a positive contribution to a signal-to-noise ratio as measured at the first signal utilization module resulting from attenuation of noise exceeds a negative contribution to the signal-to-noise ratio resulting from the first divided signal propagation losses.

The second signal utilization module may be communicatively coupled to the amplifier along a second signal propagation path having a length directly proportional to second divided signal propagation losses; and the attenuation distance and the length of the second signal propagation path can be selected such that a positive contribution to a signal-to-noise ratio as measured at the second signal utilization module resulting from attenuation of noise exceeds a negative contribution to the signal-to-noise ratio resulting from the second divided signal propagation losses.

The signal may be sent by a GPS and one of the first and second signal utilization modules may be a dedicated GPS module. The other of the first and second signal utilization modules may be a WAN radio module and the method may also include transmitting a WAN radio signal that includes location data obtained from the signal.

A power source may be electrically coupled to a bias tee in order to supply power to the amplifier. The bias tee can be communicatively coupled between the signal divider and the amplifier such that the power source supplies power to the amplifier.

The antenna may be a patch antenna disposed on a printed circuit board. The patch antenna may include a rectangular antenna trace having two ends, two parasitic reflectors, and two gaps, and each of the ends of the antenna trace may be spaced from one of the parasitic reflectors by one of the gaps.

Alternatively, the antenna may be a fractal antenna disposed on a printed circuit board having an antenna trace electrically coupled to an adjacent ground plane. The ground plane may have one or more pigtails extending therefrom. The ground plane may be substantially rectangular and have two opposed side edges disposed between two opposed end edges, wherein a first pigtail extends from a first end of one of the end edges and a second pigtail extends from a second end of the one of the end edges, and wherein the first and second pigtails are of different lengths.

### BRIEF DESCRIPTION OF THE DRAWINGS

In the accompanying drawings, which illustrate one or more exemplary embodiments:

FIG. 1 is a perspective view of one embodiment of a mobile communication device;

FIG. 2 is an exploded view depicting the contents of an endcap of the mobile communication device of FIG. 1;

FIG. 3 is a block diagram of a microprocessor and various components connected to the microprocessor, which form part of the mobile communication device of FIG. 1;

FIG. 4 is a schematic of one embodiment of a system for sharing a signal received by an antenna, which can form part of the mobile communication device of FIG. 1;

FIG. 5 is a schematic of a second embodiment of a system for sharing a signal received by an antenna, which can form part of the mobile communication device of FIG. 1;

FIG. 6(a) is a top plan view of an antenna radiator formed on one layer of a printed circuit board used in a first embodiment of an active antenna that can be used in the embodiments of the system depicted in FIGS. 4 and 5;

FIG. 6(b) is a top plan view of a ground plane matched to the antenna radiator of FIG. 6(a) and formed on a second layer of the printed circuit board used in the first embodiment of the active antenna;

FIG. 6(c) is a top plan view of a component layer formed on a third layer of the printed circuit board used in the first embodiment of the active antenna;

FIG. 7(a) is a top plan view of an antenna radiator and a ground plane formed on one layer of the printed circuit board used in a second embodiment of the active antenna that can be used in the embodiments of the system depicted in FIGS. 4 and 5;

FIG. 7(b) is a top plan view of a component layer formed on a second layer of the printed circuit board used in the second embodiment of the active antenna; and

FIG. 8 is a flowchart depicting an embodiment of a method for sharing a signal received by an antenna.

### DETAILED DESCRIPTION OF THE PREFERRED EMBODIMENTS

In recent years, legislatures in many jurisdictions have enacted laws requiring telecommunication utilities to provide wireless Enhanced 911 (“E911”) services. Without E911 services, emergency responders cannot automatically determine the location of an emergency caller; the emergency caller needs to manually inform the emergency responders as to his or her location. Unfortunately, it is often not feasible or realistic to expect the emergency caller to provide such information.

With E911 services, a mobile communication device used by the emergency caller automatically determines and transmits the emergency caller's location information to the emergency responders. Various ways exist for the mobile communication device to determine the location information. For example, the mobile communication device may determine the location information by triangulating location using signals from cellular towers. Alternatively, the mobile communication device may determine the location information using signals sent by a global positioning system (GPS).

The embodiments described below are directed at a mobile communication device that relies on GPS signals to automatically determine the emergency caller's location information and that automatically transmits the location information to the emergency responders when an emergency call is made. Beneficially, the embodiments described below allow the GPS signal received by a single GPS antenna to be shared between a dedicated GPS module and a WAN radio module having E911 functionality, instead of requiring each of the modules to be connected to separate GPS antennas. As described in more detail below, sharing the single GPS antenna results in both space and cost savings over systems where two separate GPS antennas are required.

Directional terms such as “top”, “bottom”, and “upwards” are used in the following description for the purpose of providing relative reference only, and are not intended to suggest any limitations on how any apparatus is to be positioned during use, or to be mounted in an assembly or relative to an environment.

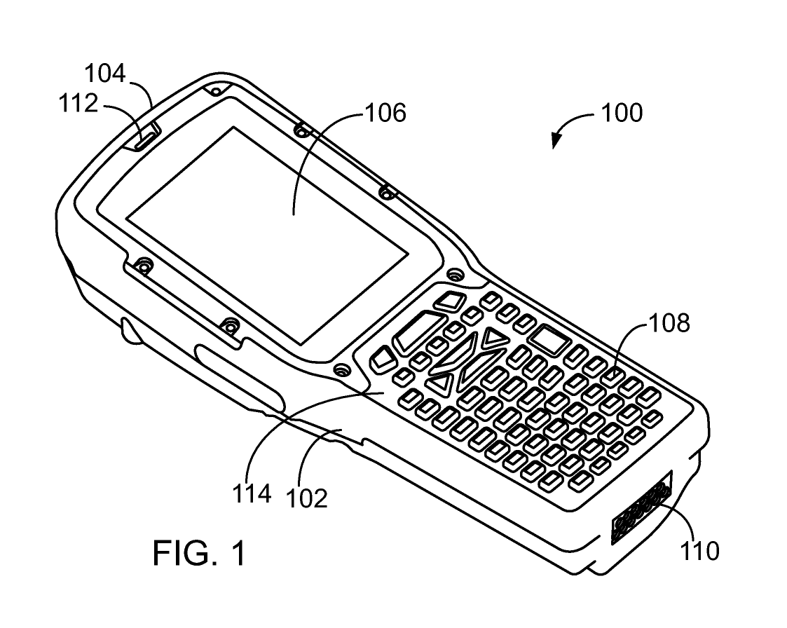

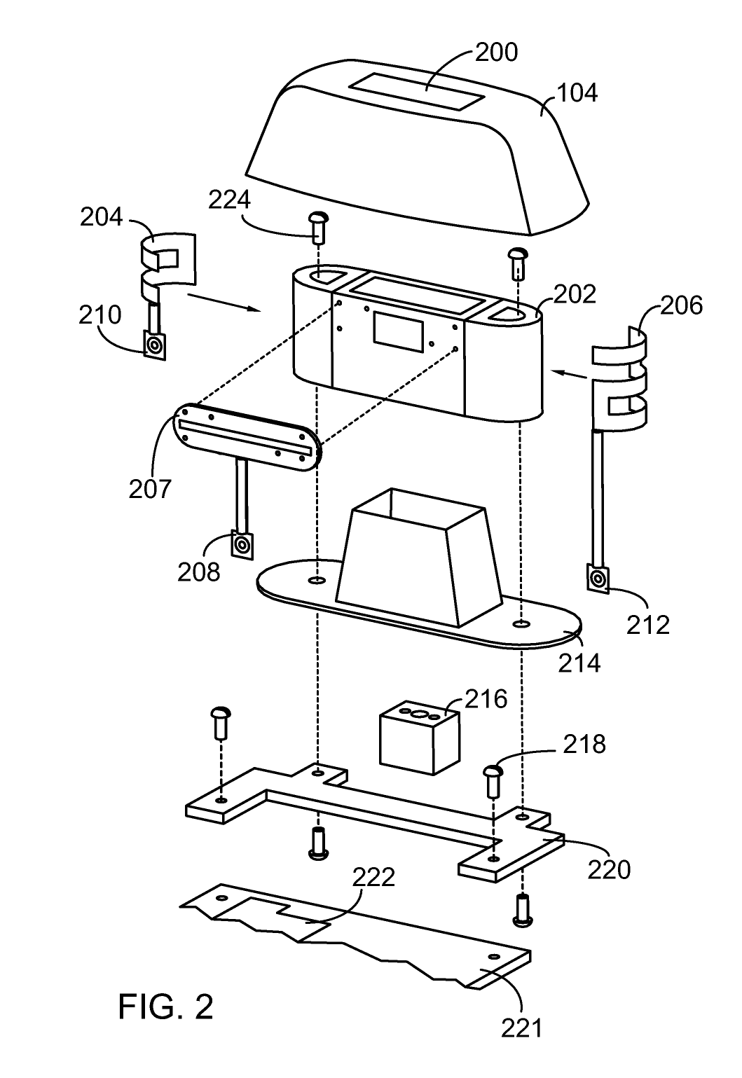

Referring now to FIG. 1, there is depicted a mobile communication device 100 (hereinafter interchangeably referred to as a “mobile device” 100) having a main body 102 and an endcap 104 connected to one end of the main body 102. As described in greater detail in relation to FIG. 2, below, the endcap 104 houses one or more directional antennas and is therefore typically pointed upwards when the mobile device 100 is in use. The main body 102 also includes a keyboard 108, a touchscreen display 106, a speaker 112 and a microphone 114 to allow a user to interface with the mobile device 100. A docking port 110 is present at the bottom of the mobile device 100 to allow the mobile device 100 to be connected to a docking cradle (not shown). The docking port 110 allows the mobile device 100 to receive power from and to communicate information via the docking cradle when docked.

Referring now to FIG. 2, there is depicted an exploded view of the contents of the endcap 104. The endcap 104 is detachably connected to the main body 102 using mounting screws 224 such that the user may remove the endcap 104 from the main body 102 to access the contents depicted in FIG. 2.

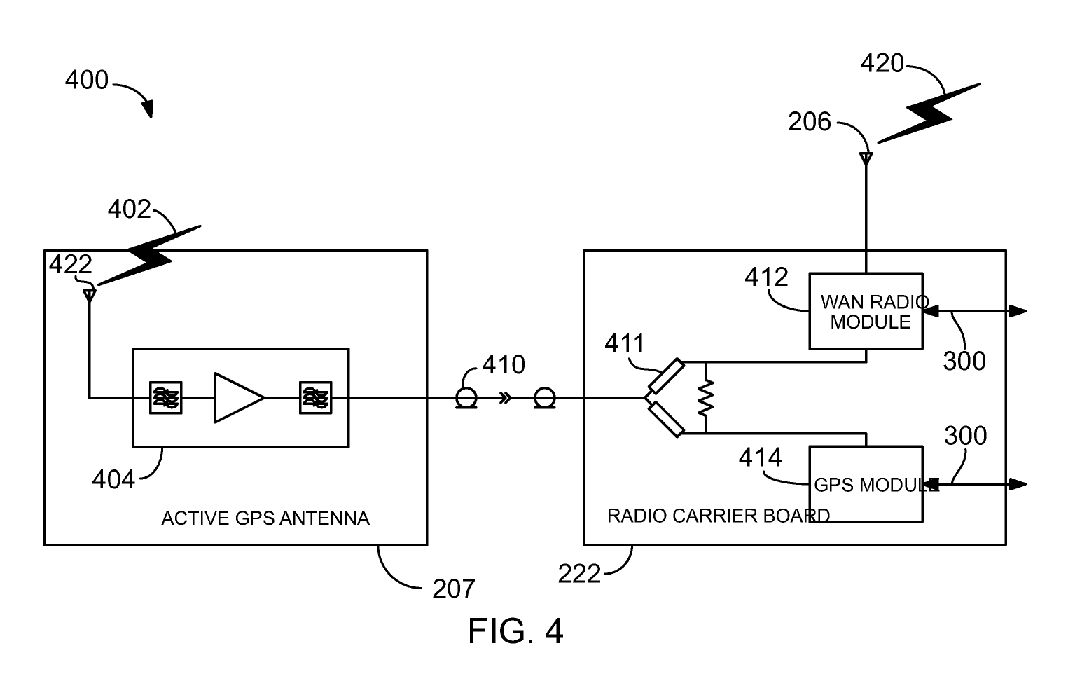

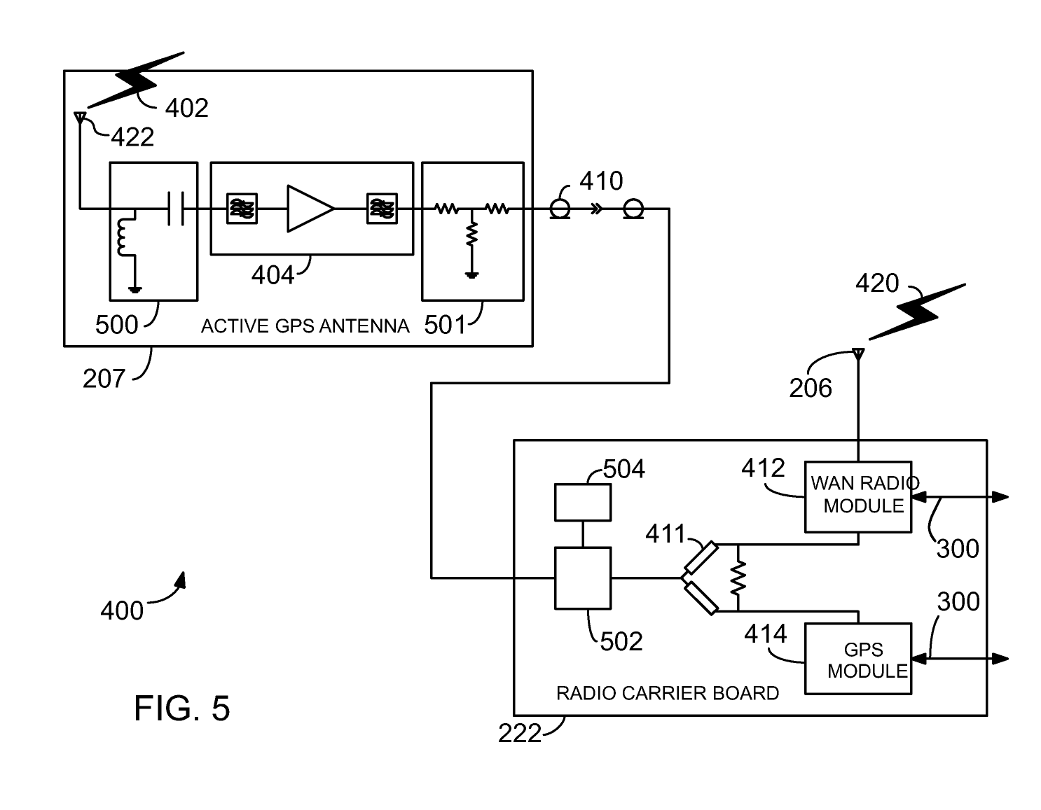

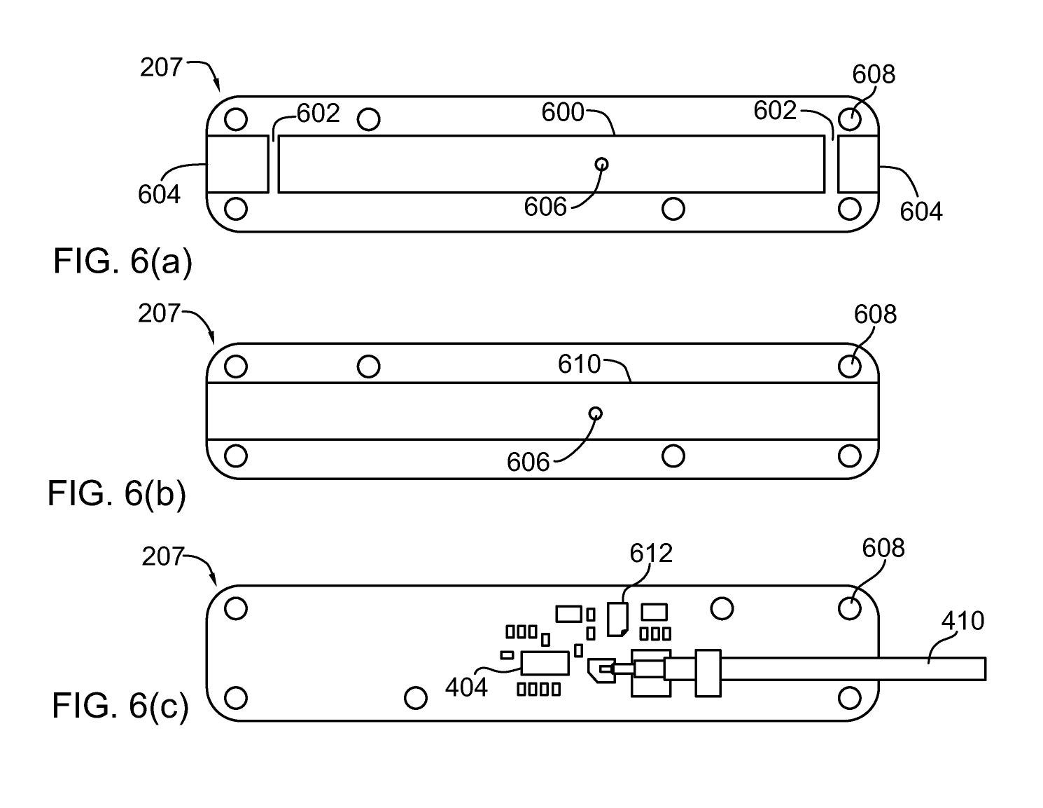

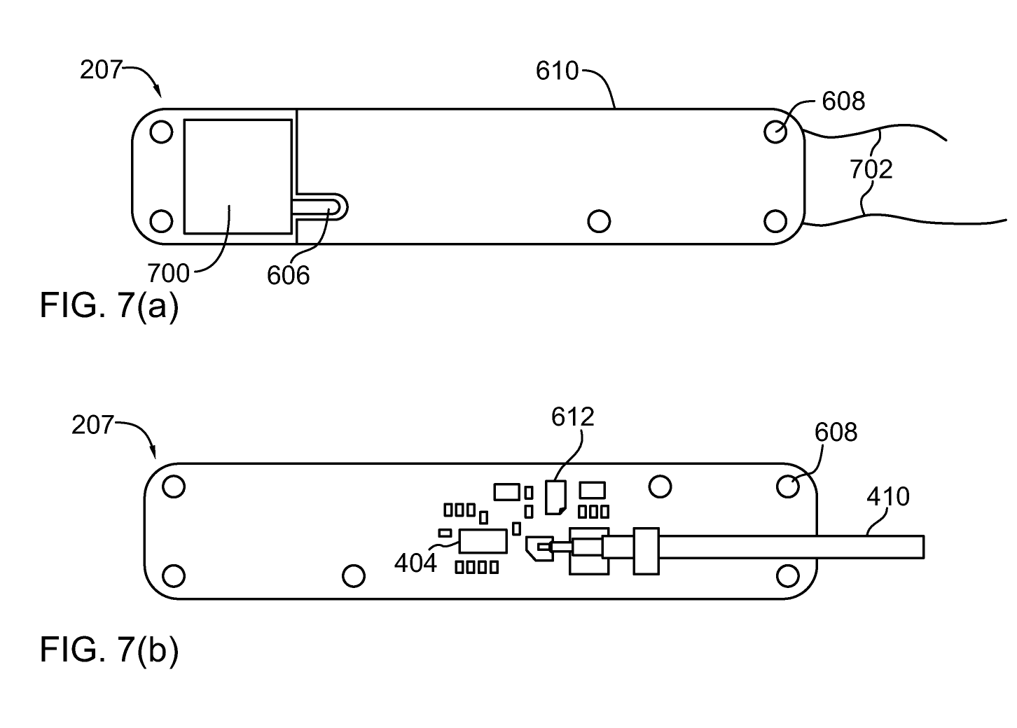

In FIG. 2, the components that are housed within the endcap 104 are electrically coupled to a main circuit board 221 that is housed within the main body 102. Metal screws 218 physically and electrically connect a grounding bracket 220 to a ground plane of the main circuit board 221, thereby providing an electrical connection to ground for the components housed within the endcap 104. A conductive scanner bracket 214 housing a bar code scanner 216 is also physically and electrically connected to the grounding bracket 220 using the screws 218. A scanner window 200 present in the endcap 104 allows the scanner 216 to scan barcodes using infrared light. Fitted over the scanner bracket 214 is a non-conductive plastic frame 202 to which three different antennas are secured: a dedicated WAN (Wide Area Network) radio antenna 206; a diversity WAN radio antenna 204; and an active GPS antenna 207. The grounded scanner bracket 214 acts as a ground plane for the WAN radio antenna 206 and the diversity WAN radio antenna 204; as discussed in more detail in respect of FIGS. 6 and 7, below, the active GPS antenna 207 has its own ground plane. As discussed in more detail in FIGS. 4 and 5 below, the mobile device 100 transmits and receives cellular voice and data communications via the WAN radio antenna 206 and receives GPS signals used for the E911 service and for other GPS applications such as mapping programs. The diversity WAN radio antenna 204 provides the mobile device 100 with spatial diversity, which increases the quality and reliability of transmitted and received WAN radio signals. Each of the WAN radio antenna 206, the diversity WAN radio antenna 204, and the active GPS antenna 207 are physically and electrically coupled to a radio carrier printed circuit board 222 (hereinafter referred to as a “radio carrier board 222”) using antenna connectors 206, 210, 208, respectively; the radio carrier board 222 is discussed in more detail with respect to FIGS. 4 and 5, below. The main circuit board 221 and the radio carrier board 222 each generate noise by virtue of being populated with powered electrical components. As discussed in more detail below, locating the active GPS antenna 207 remote from the boards 221, 222 in the endcap 104 isolates the active GPS antenna 207 and consequently the received GPS signals from the noise, and facilitates a high signal-to-noise ratio during signal processing.

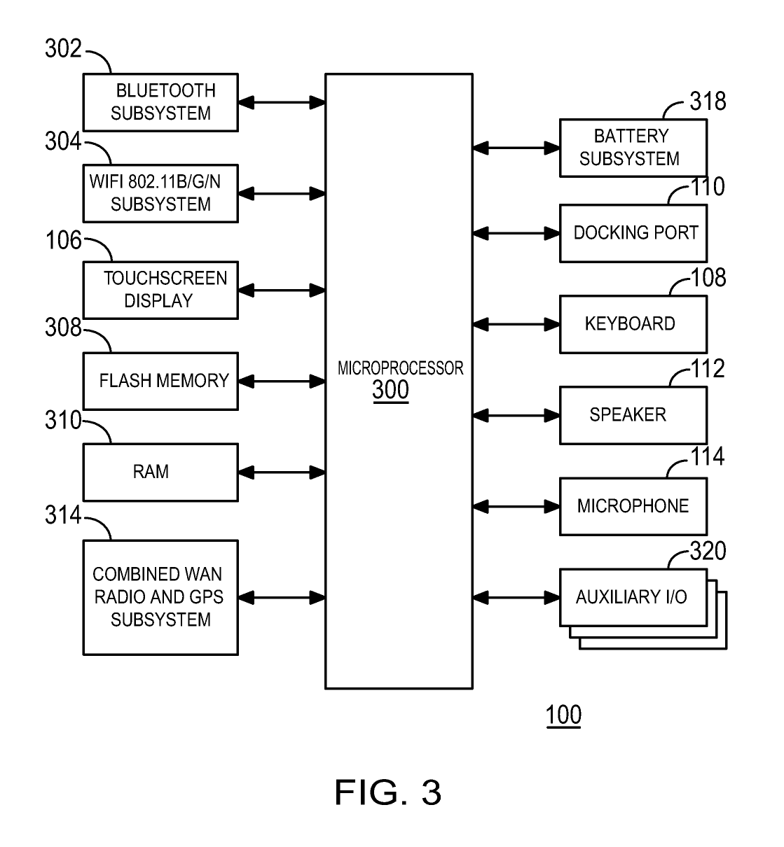

Referring now to FIG. 3, there is shown a schematic of a main processor 300 that is located on the main circuit board 221 of the mobile device 100, and of the various functional device subsystems with which the main processor 300 communicates and that are used to implement at least a portion of the functionality that the mobile device 100 provides. The depicted functional device subsystems are a Bluetooth™ short-range communications subsystem 302; a WiFi™ 802.11b/g/n wireless communication subsystem 304; the touchscreen display 106; a persistent store such as flash memory 308; a volatile store such as random access memory (RAM) 310; a combined WAN radio and GPS subsystem 314 for communicating voice and data over a cellular network and for receiving and decoding GPS signals; a battery subsystem 318 configured to manage and draw power from a rechargeable battery (not shown); the docking port 110; the keyboard 108; components of an audio subsystem including the microphone 114 and speaker 112; and auxiliary input/output devices such as a Universal Serial Bus port. Skilled persons will recognize that in alternative embodiments (not depicted), additional or fewer functional device systems may be utilized.

Operating system software used by the microprocessor 300 may be stored in the flash memory 308, which may alternatively be a read-only memory (ROM) or similar storage element (not shown). Those skilled in the art will appreciate that the operating system, specific device applications, or parts thereof, are temporarily loaded into the RAM 310 when executed by the microprocessor 300. An exemplary operating system is the Windows CE™ operating system.

The microprocessor 300, in addition to executing the operating system, enables execution of software applications on the mobile device 100. A predetermined set of applications, which control basic functionality of the mobile device 100, may be installed on the mobile device 100 during its manufacture. These basic operations typically include data and voice communication applications that utilize the functionality of the combined WAN radio and GPS subsystem 314, for example.

Referring now to FIG. 4, there is depicted a first embodiment of a system 400 for sharing a GPS signal 402 received by the active GPS antenna 207. The active GPS antenna 207 includes an antenna 422 that is electrically coupled to the input of an amplifier package 404 and that is tuned to the frequency of the GPS signal 402, which in the present embodiment is 1.57542 GHz. The amplifier package 404 is composed of a low noise amplifier (LNA), the input and output of which are each electrically coupled to frequency filters. The amplifier package 404 can be purchased as an integrated circuit; for example, the Avago Technologies™ ALM-1712 front end module can be used. The amplifier package 404 outputs an amplified GPS signal, which is transmitted using a transmission line such as a coaxial cable 410. In the present embodiment, the amplifier package 404 amplifies the GPS signal by about 10 dB. DC power carried along the coaxial cable 410 is used to power the amplifier package 404 according to techniques known to skilled persons. As shown in more detail in FIGS. 6 and 7, the active GPS antenna 207 is manufactured using traces and components on a printed circuit board.

The coaxial cable 410 transmits the amplified GPS signal to the radio carrier board 222. The radio carrier board 222 has on it a signal divider in the form of a RF splitter 411 that receives the amplified GPS signal from the coaxial cable 410 and that divides it into a first divided signal and a second divided signal. The RF splitter 411 is commercially available as a Mini-Circuits™ SP-2G+ power splitter, for example. The first divided signal is routed to a dedicated GPS module 414 that is communicatively coupled to the microprocessor 300 and that uses the first divided signal for all GPS applications made available to the user with the exception of the E911 services. A Navman™ AA003255-G may be used as the GPS module 414. The second divided signal is routed to a WAN radio module 412 having E911 functionality that is also communicatively coupled to the microprocessor 300. More particularly, the second divided signal is routed to an E911 GPS input of the WAN radio module 412. When the user places an emergency call, the WAN radio module 412 determines the user's location information from the second divided signal and transmits the location information along with voice communication to a cellular tower (not shown) using a WAN radio signal 420 via the WAN radio antenna 206. In this way, emergency responders are able to accurately locate the user of the mobile device 100 without waiting for the user to manually provide the location information. The WAN radio module 412 is commercially available and may be a Cinterion™ PH-8 WAN radio module.

Referring now to FIG. 5, there is depicted a second embodiment of the system 400 for sharing the GPS signal 402 received by the active GPS antenna 207. The embodiment of the system 400 depicted in FIG. 5 is substantially similar to the embodiment depicted in FIG. 4 with the following exceptions.

One difference between the embodiment of FIG. 4 and the embodiment of FIG. 5 is the use of matching networks 500, 501 between the antenna 422 and the input of the amplifier package 404 and between the output of the amplifier package 404 and the coaxial cable 410. The matching network 500 between the antenna 422 and the input of the amplifier package 404 is used to minimize or eliminate reflections of the GPS signal 402 from the input of the amplifier package 404 to the antenna 422, and is an LC matching circuit. The matching network 501 between the output of the amplifier package 400 and the input of the coaxial cable 410 is used to minimize or eliminate reflections of the amplified GPS signal 402 from the input of the coaxial cable 410 to the output of the amplifier package 404, and is a lumped-element inductor-capacitor circuit. In the embodiment of the system 400 depicted in FIG. 4, the matching network 501 between the amplifier package 404 and the coaxial cable 410 is not required because the output impedance of the amplifier package 400, the characteristic impedance of the coaxial cable 410 and the input impedance of the radio carrier board 222 are identical (e.g.: 50 Ohms). The embodiment of the system 400 depicted in FIG. 4 also does not require the matching network 500 between the antenna 422 and the amplifier package 404 because the electrical length of the antenna 422 has been adjusted through trial and error until it is empirically determined that all significant signal reflections have been eliminated. Adjustments made to the electrical length of the antenna 422 to achieve this are discussed in more detail in respect of FIG. 6, below. Selecting specific values for the components used in the matching networks 500, 501, as well as accordingly designing printed circuit board traces and laying components to minimize reflections can be done utilizing techniques known to skilled persons.

Another difference between the embodiment of FIG. 4 and the embodiment of FIG. 5 is that DC power is supplied to the amplifier package 404 via a DC power source 504 and a bias tee 502 in FIG. 5 as opposed to being routed through the RF splitter 411 in FIG. 4. The DC power source 504 may be, for example, an Austriamicrosystems™ AS1359-BTTT-31 voltage regulator. The bias tee 502 allows DC power to be conducted to the amplifier package 404 while allowing the amplified GPS signal to pass through to the RF splitter 411 and may be, for example, a Mini-circuits™ TCBT-2R5G+ bias tee. Advantageously, in the embodiment of FIG. 5 the power signal that the DC power source 504 provides typically is of higher quality (e.g.: better regulated and has greater noise suppression) than when DC power is supplied directly from the GPS module 414. Furthermore, the embodiment of FIG. 5 allows the GPS module 414 to be of a type that does not output DC power; this allows a less expensive type of GPS module to be used. Additionally, the radio carrier board 222 of FIG. 5 promotes modularity in that the GPS module 414 can be removed and the active GPS antenna 207 will still be powered by the DC power source 504. This allows a less expensive version of the mobile device 100 to be sold without the GPS module 414 and consequently without dedicated GPS functionality, while still allowing the WAN radio module 412 to have access to the GPS signal 402 without having to manufacture a radio carrier board that fundamentally differs in design from the radio carrier board 222.

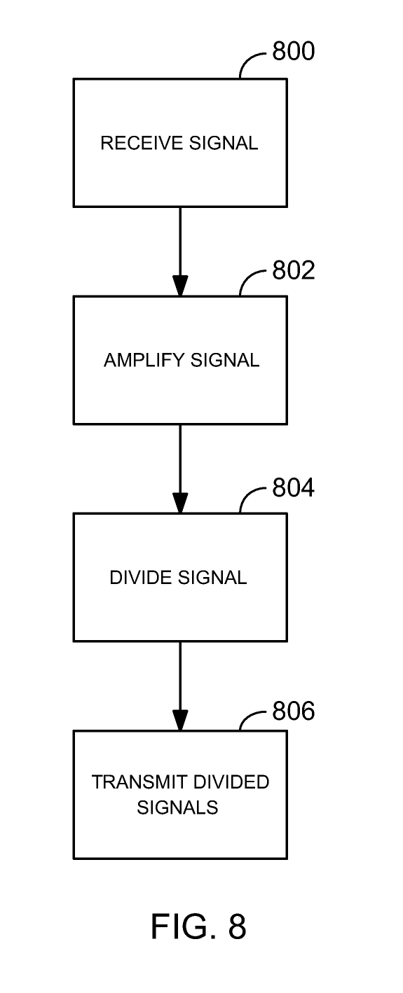

Referring now to FIG. 8, there is depicted an exemplary method by which the mobile device 100 incorporating either of the embodiments of the system 400 for sharing the GPS signal 402 can be utilized. The GPS signal 402 is first received using the antenna 422 (block 800). As mentioned above, the antenna 422 is tuned to the frequency at which the GPS signal 402 is transmitted. Following receipt of the GPS signal 402, the GPS signal 402 is amplified (block 804) so as to prepare the GPS signal 402 for being split and shared. While in the present embodiments the amplifier package 404 is used to amplify the GPS signal 402, in alternative embodiments any suitable means for amplification as is known to skilled persons may be used. The amplified signal is then divided (block 804) and, in the present embodiment, is transmitted (block 806) to different destinations. While in the present embodiment the amplified signal is split into two and is sent to the WAN radio module 412 and the GPS module 414, in alternative embodiments the amplified signal can be divided unequally into the two divided signals or can be divided into any number of divided signals and sent to various destinations. The destinations for the divided signals can be, for example, multiple integrated circuits on a single printed circuit board, multiple integrated circuits on multiple circuit boards, or different input pins on a single integrated circuit.

Utilizing either of the embodiments of the system 400 for sharing the GPS signal 402 depicted in FIGS. 4 and 5 is advantageous for multiple reasons. First, utilizing the system 400 allows both the WAN radio module 412 and the GPS module 414 to receive the GPS signal 402 using one antenna 422 as opposed to using two antennas. Beneficially, manufacturing the mobile device 100 with only one GPS antenna is less expensive than manufacturing it with two antennas. Additionally, the antenna 422 is placed in the endcap 104 of the mobile device 104 so that the antenna 422 is oriented upwards when the mobile device 100 is in use; this allows the antenna 422 to better acquire the GPS signal 402. When the mobile device 100 incorporates the system 400 for sharing the GPS signal 402, only the single antenna 422 for acquiring the GPS signal 402 is fitted within the endcap 104. In the present embodiment of the mobile device 100, this allows the endcap 104 to have a height of approximately 25 mm measured from the top edge of the main body 102 to the top of the endcap 104. In contrast, if two GPS antennas had to be fitted within the endcap 104, the height of the endcap would increase by approximately 10-15 mm, making the mobile device 100 heavier and bulkier. The space savings in the endcap 104 that result from using the system 400 for sharing the GPS signal 402 allow additional antennas (not shown) to be fitted within the endcap 104 if desired. These additional antennas can be used to increase receive diversity, which results in the user experiencing increased signal reliability.

In the foregoing embodiments, the printed circuit board on which the active GPS antenna 207 resides is distinct from and is located remote from the radio carrier board 222 and the main circuit board 221. Each of the radio carrier board 222 and the main circuit board 221 act as noise sources. The distance from any one of the noise sources and the input of the amplifier package 404 is referred to as an “attenuation distance”; noise generated by any one of the noise sources decreases according to the inverse square law over the attenuation distance such that noise strength as measured at the input of the amplifier package 404 is less than the noise strength as measured at the noise source. In this way, locating the active GPS antenna 207 in the endcap 104 when the noise sources are located in the main body 102 reduces noise interference on the GPS signal 402, which contributes to a high signal-to-noise ratio. The amplifier package 404 amplifies the GPS signal 402 before the GPS signal is transmitted to the radio carrier board 222 and exposed to relatively high levels of noise, which also contributes to a high signal-to-noise ratio.

However, locating the active GPS antenna 207 in the endcap 104 remote from the noise sources in the main body 102 increases the distance over which the GPS signal 402 propagates over the coaxial cable 410 prior to being utilized in the WAN radio module 412 and the GPS module 414. While locating the active GPS antenna 207 remotely from the noise sources attenuates the noise, which positively contributes to signal-to-noise ratio, doing so also increases propagation losses of the amplified GPS signal over the coaxial cable 410, which negatively contributes to signal-to-noise ratio as measured at the WAN radio and GPS modules 412, 414. In each of the embodiments of FIGS. 4 and 5, the signal strength of the first divided signal suffers from propagation losses that occur along a propagation path that begins at the antenna 422 and travels through the amplifier package 404, the coaxial cable 410, the RF splitter 411, and ends at the input of the GPS module 414. The second divided signal suffers from propagation losses that occur along a propagation path that begins at the antenna 422 and travels through the amplifier package 404, the coaxial cable 410, the RF splitter 411, and ends at the input of the WAN radio module 412. These propagation losses, which lower or otherwise impair the signal strength of each of the first and second divided signals (“first divided signal propagation losses” and “second divided signal propagation losses”, respectively), increase directly with the length of the coaxial cable 410. In the present embodiments, when the coaxial cable 410 is about 72 mm long, each of the first and second divided signal propagation losses is about 0.5 dB. In contrast, by locating the active GPS antenna 207 in the endcap 104, noise from the noise sources in the main body 102 is attenuated by at least about 3 dB. The active GPS antenna 207 is located such that the positive contributions to signal-to-noise ratio as measured at the WAN radio and GPS modules 412, 414 resulting from attenuation of noise over the attenuation distance exceeds the negative contributions to the signal-to-noise ratio resulting from the portion of the first and second divided signal propagation losses that are attributed to locating the active GPS antenna remotely from the noise sources; in the present embodiment, this corresponds substantially to the portion of the first and second divided signal losses that occur over the coaxial cable 410 and to connector mating associated with the coaxial cable 410, which total about 0.3 dB. Determining exactly where to locate the active GPS antenna 207 can be determined empirically or with appropriate computer modeling software. Although in the depicted embodiments the RF splitter 411 is located after the coaxial cable 410, in alternative embodiments (not depicted) the RF splitter 411 may be located before the coaxial cable 410, and the first and second divided signals may each be transmitted on separate coaxial cables.

Furthermore, locating the active GPS antenna 207, the WAN radio antenna 206 and the diversity WAN radio antenna 212 in the endcap 104 results in the mobile device 100 being modular in construction. Should the user desire to replace any of the antennas 207, 206, 212, the user can gain easy access to the antennas 207, 206, 212 simply by removing the endcap 104 from the main body 102.

In the foregoing embodiments the primary purpose of the amplifier package 404 is to amplify the GPS signal 402 in preparation for being split to the WAN radio module 412 and the GPS module 414. Without amplification, the GPS signal 402 as received by the antenna 422 is too weak to be split and still be useful, as the power of the GPS signal 402 is more than divided in half when it is split as a result of being divided and as a result of the insertion loss of the RF splitter 411. One beneficial unintended consequence of amplifying the GPS signal 402 is that in addition to allowing it to be split, which allows the WAN radio module 412 and the GPS module 414 to share the antenna 422, the signal that each of the WAN radio module 412 and GPS module 414 receive is more powerful and has a higher signal-to-noise ratio than if the antenna 422 were not being shared and either of the modules 412, 414 were directly connected to the antenna 422. In addition to resulting from locating the active GPS antenna 207 in the endcap 104 as discussed above, this higher signal-to-noise ratio results from the amplifier package 404 amplifying the signal prior to sending it to the radio carrier board 222; from the amplifier package 404 having a lower noise figure than the internal amplifiers used within the WAN radio module 412 and the GPS module 414; and from the gain of the amplifier package 404 being sufficient to render the noise figures of the electronic components on the radio carrier board 222 relatively insignificant compared to the noise figure of the amplifier package 404.

In the present embodiment, the amplifier package 404 amplifies the GPS signal 402 by approximately 10 dB, the RF splitter 411 reduces the power of the amplified signal by approximately 3.5 dB and propagation losses for each of the first and second divided signals are about 0.5 dB such that the power of each of the first and second divided signals is approximately 6 dB higher than that of the GPS signal 402. This higher signal strength translates a higher signal-to-noise ratio. In many conventional applications it is not commercially justifiable to amplify the GPS signal 402 if it is being sent solely to one module; however, when the GPS signal 402 is to be shared between the two modules 412, 414, the amplification that is performed to facilitate signal sharing also beneficially increases signal-to-noise ratio.

Referring now to FIGS. 6(a)-(c) and FIGS. 7(a) and (b), there are depicted two embodiments of the active GPS antenna 207 as formed on a printed circuit board. In FIGS. 6(a)-(c) the active GPS antenna 207 utilizes a patch antenna; in FIGS. 7(a)-(b) the active GPS antenna 207 utilizes a fractal antenna.

In FIG. 6(a), an antenna radiator is depicted. The antenna radiator includes an antenna trace 600 that is rectangular in shape and has two ends. Each of the ends is spaced from a parasitic reflector 604, which enhances portions of the GPS signal 402 for reception by the antenna trace 600, by a gap 602. The parasitic reflectors 604 help to make the active GPS antenna 207 more directional. A feedpoint 606 through which the GPS signal 402 is transmitted to the amplifier package 404 is located within the antenna trace 600. Mounting pegs 608 are also present to mount the printed circuit board as desired. In FIG. 6(b), an antenna ground plane 610 is depicted. The ground plane 610 is electrically coupled to the antenna trace 600 and is matched to the antenna radiator depicted in FIG. 6(a). The ground plane 610 is rectangular in shape and overlaps with and has the same dimensions as the rectangle formed by the concatenation of the antenna trace 600, the two gaps 602, and the two parasitic reflectors 604. In FIG. 6(c), a component layer of the printed circuit board is depicted. The component layer includes elements such as the amplifier package 404 and a voltage regulator 612. The coaxial cable 410 that couples the active GPS antenna 207 to the radio carrier board 222 is also illustrated as being physically and electrically coupled to electrically conductive pads on the printed circuit board. Each of FIGS. 6(a)-(c) depict one layer of the printed circuit board; the layers illustrated in FIGS. 6(a) and (c) are on the exterior of the printed circuit board, while the layer having the ground plane 610 in FIG. 6(b) is sandwiched between the exterior layers.

In FIG. 7(a), both the antenna radiator and the antenna ground plane are depicted. The antenna radiator includes the antenna trace (not shown) that is shaped in a fractal pattern and is located on an antenna chip 700. The antenna chip 700 is square in shape and a tab, on which the feedpoint 606 is located, protrudes from one of the sides of the antenna chip 700. The antenna chip may be, for example, a Fractus™ FR05-S1-E-0-103. Adjacent and electrically coupled to the antenna trace 600 is the ground plane 610. The ground plane 610 is substantially rectangular, and has two shorter end edges located between two longer side edges. From the leftmost end edge are soldered two pigtails 702, which alter the electrical length of the antenna 422 and whose length and position can be altered so as to facilitate tuning of the antenna 422. Beneficially, through experimentation it has been found that locating the pigtails 702 as depicted in FIG. 7(a) and having them unequal in length allow the ground plane 610 to be made shorter than it would otherwise have to be made; i.e., the pigtails 702 allow the longer sides of the ground plane 610 as depicted in FIG. 7(a) to be reduced in length. The unequal length of the pigtails 702 has been found to increase bandwidth of the antenna 422, which is particularly useful when the antenna 422 is placed in the endcap 104 and near metal. The pigtails 702 can also be affixed to the ground plane 610 in alternative orientations. For example, depending on design parameters, one or more of the pigtails 702 may be affixed to the longer side of the ground plane 610, which would allow the shorter sides of the ground plane 610 to be reduced in length. In FIG. 7(b), the component layer of the printed circuit board is depicted, which in the present embodiment is identical to the component layer used in conjunction with the patch antenna and as depicted in FIG. 6(c).

In the embodiments of FIGS. 6(a)-(c) and 7(a) and (b), the size and shape of the antenna trace 600, ground plane 704 and pigtails 702 can be determined empirically. In both embodiments, the printed circuit board on which the antenna trace 600 is placed has a length of approximately 67 mm and a height of approximately 13 mm. In the embodiment of FIGS. 6(a)-(c), the rightmost parasitic reflector 604 has a length of approximately 4 mm; each of the gaps 602 has a length of approximately 1.2 mm; the antenna trace 600 has a length of approximately 54.6 mm; the leftmost parasitic reflector 604 has a length of approximately 6 mm; and the feedpoint 606 is located approximately 27 mm from the rightmost edge of the printed circuit board. The height of the antenna trace 600 is about 6 mm. In the embodiment of FIGS. 7(a) and (b), the ground plane 610 has a length of about 51 mm and a height of approximately 13 mm. The dimensions of the pigtails 702 can be determined through known trial and error methods and will vary depending on the environment in which the active GPS antenna 207 is used.

While the foregoing embodiments discuss specifically sharing the GPS signal 402, in alternative embodiments (not depicted) the signal that is shared between various destinations or modules is not sent from the GPS. The shared signal may be sent from any suitable source, such as a cellular tower. Furthermore, although in the foregoing embodiments the first divided signal is sent to the GPS module 414 and the second divided signal is sent to the WAN radio module 412, in alternative embodiments the first divided signal may be sent to the WAN radio module 412 and the second divided signal may be sent to the GPS module 414, or the first and second divided signals may be sent to entirely different types of modules.

For the sake of convenience, the embodiments above are described as various interconnected functional blocks. This is not necessary, however, and there may be cases where these functional blocks or modules are equivalently aggregated into a single logic device or operation with unclear boundaries. In any event, the functional blocks or features can be implemented by themselves, or in combination with other operations in either hardware or software.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. A system for sharing a signal received by an antenna, the system comprising:
(a) an amplifier communicatively coupled to the antenna to receive the signal and configured to output an amplified signal, the amplifier disposed an attenuation distance away from a noise source wherein the attenuation distance is inversely proportional to noise strength as measured at the amplifier;
(b) a signal divider communicatively coupled to the amplifier to receive the amplified signal and configured to divide the amplified signal into a first divided signal and a second divided signal;
(c) a first signal utilization module communicatively coupled to the signal divider to receive the first divided signal and communicatively coupled to the amplifier via the signal divider along a first signal propagation path having a length directly proportional to first divided signal propagation losses; and
(d) a second signal utilization module communicatively coupled to the signal divider to receive the second divided signal,
wherein the attenuation distance and the length of the first signal propagation path are selected such that a positive contribution to a signal-to-noise ratio as measured at the first signal utilization module resulting from attenuation of noise exceeds a negative contribution to the signal-to-noise ratio resulting from the first divided signal propagation losses attributed to locating the amplifier the attenuation distance away from the noise source.

2. A system as claimed in claim 1 wherein:
(a) the second signal utilization module is also communicatively coupled to the amplifier via the signal divider along a second signal propagation path having a length directly proportional to second divided signal propagation losses; and
(b) the attenuation distance and the length of the second signal propagation path are selected such that a positive contribution to a signal-to-noise ratio as measured at the second signal utilization module resulting from attenuation of noise exceeds a negative contribution to the signal-to-noise ratio resulting from the second divided signal propagation losses attributed to locating the amplifier the attenuation distance away from the noise source.

3. A system as claimed in claim 2 wherein the signal is sent by a global positioning system (GPS) and one of the first and second signal utilization modules comprises a dedicated GPS module.

4. A system as claimed in claim 3 wherein the other of the first and second signal utilization modules comprises a WAN radio module communicatively coupled to a WAN antenna and wherein the WAN radio module transmits a WAN radio signal comprising location data obtained from the signal sent by the GPS.

5. A system as claimed in claim 1 further comprising a power source electrically coupled to a bias tee and wherein the bias tee is communicatively coupled between the signal divider and the amplifier such that the power source supplies power to the amplifier.

6. A system as claimed in claim 1 wherein the antenna comprises a patch antenna disposed on a printed circuit board, the patch antenna comprising a rectangular antenna trace having two ends, two parasitic reflectors, and two gaps, and wherein each of the ends of the antenna trace is spaced from one of the parasitic reflectors by one of the gaps.

7. A system as claimed in claim 1 wherein the antenna comprises a fractal antenna disposed on a printed circuit board comprising an antenna trace electrically coupled to an adjacent ground plane.

8. A system as claimed in claim 7 wherein the ground plane comprises one or more pigtails extending therefrom.

9. A system as claimed in claim 8 wherein the ground plane is substantially rectangular and comprises two opposed side edges disposed between two opposed end edges, wherein a first pigtail extends from a first end of one of the end edges and a second pigtail extends from a second end of the one of the end edges, and wherein the first and second pigtails are of different lengths.

10. A mobile communication device, comprising:
(a) a main body and an endcap detachably coupled to one end of the main body;
(b) wherein the endcap has disposed therein:
(i) an antenna configured to receive a signal; and
(ii) an amplifier communicatively coupled to the antenna to receive the signal and to output an amplified signal; and
wherein the main body has disposed therein:
(i) a processor;
(ii) a memory communicatively coupled to the processor and having statements and instructions encoded thereon for execution by the processor to configure the mobile communication device to communicate wirelessly;
(iii) a signal divider communicatively coupled to the amplifier to receive the amplified signal and configured to divide the amplified signal into a first divided signal and a second divided signal; and
(iv) first and second signal utilization modules each communicatively coupled to the processor wherein the first signal utilization module is also communicatively coupled to the signal divider to receive the first divided signal and the second signal utilization module is also communicatively coupled to the signal divider to receive the second divided signal.

11. A mobile communication device as claimed in claim 10 wherein the signal is sent by a GPS and one of the first and second signal utilization modules comprises a dedicated GPS module.

12. A mobile communication device as claimed in claim 11 further comprising a WAN antenna disposed in the endcap and wherein the other of the first and second signal utilization modules comprises a WAN radio module communicatively coupled to the WAN antenna and wherein the WAN radio module transmit a WAN radio signal comprising location data obtained from the signal sent by the GPS.

13. A mobile communication device as claimed in claim 10 wherein the main body also has disposed therein a power source electrically coupled to a bias tee and wherein the bias tee is communicatively coupled between the signal divider and the amplifier such that the power source supplies power to the amplifier.

14. A mobile communication device as claimed in claim 10 wherein the antenna comprises a patch antenna disposed on a printed circuit board, the patch antenna comprising a rectangular antenna trace having two ends, two parasitic reflectors, and two gaps, and wherein each of the ends of the antenna trace is spaced from one of the parasitic reflectors by one of the gaps.

15. A mobile communication device as claimed in claim 10 wherein the antenna comprises a fractal antenna disposed on a printed circuit board comprising an antenna trace electrically coupled to an adjacent ground plane.

16. A mobile communication device as claimed in claim 15 wherein the ground plane comprises one or more pigtails extending therefrom.

17. A mobile communication device as claimed in claim 16 wherein the ground plane is substantially rectangular and comprises two opposed side edges disposed between two opposed end edges, wherein a first pigtail extends from a first end of one of the end edges and a second pigtail extends from a second end of the one of the end edges, and wherein the first and second pigtails are of different lengths.

18. A method for sharing a signal received by an antenna, the method comprising:
(a) receiving the signal from the antenna;
(b) generating an amplified signal by amplifying the signal with an amplifier, the amplifier disposed an attenuation distance away from a noise source wherein the attenuation distance is inversely proportional to noise strength as measured at the amplifier;
(c) dividing the amplified signal into a first divided signal and a second divided signal; and
(d) respectively transmitting the first and second divided signals to first and second signal utilization modules for utilization, the first signal utilization module communicatively coupled to the amplifier along a first signal propagation path having a length directly proportional to first divided signal propagation losses,
wherein the attenuation distance and the length of the first signal propagation path are selected such that a positive contribution to a signal-to-noise ratio as measured at the first signal utilization module resulting from attenuation of noise exceeds a negative contribution to the signal-to-noise ratio resulting from the first divided signal propagation losses attributed to locating the amplifier the attenuation distance away from the noise source.

19. A method as claimed in claim 18 wherein:
(a) the second signal utilization module is communicatively coupled to the amplifier along a second signal propagation path having a length directly proportional to second divided signal propagation losses; and
(b) the attenuation distance and the length of the second signal propagation path are selected such that a positive contribution to a signal-to-noise ratio as measured at the second signal utilization module resulting from attenuation of noise exceeds a negative contribution to the signal-to-noise ratio resulting from the second divided signal propagation losses attributed to locating the amplifier the attenuation distance away from the noise source.

20. A method as claimed in claim 19 wherein the signal is sent by a GPS and one of the first and second signal utilization modules comprises a dedicated GPS module.

21. A method as claimed in claim 20 wherein the other of the first and second signal utilization modules comprises a WAN radio module and further comprising transmitting a WAN radio signal comprising location data obtained from the signal.

22. A method as claimed in claim 18 wherein power is supplied to the amplifier from a power source electrically coupled to a bias tee and wherein the bias tee is communicatively coupled between the signal divider and the amplifier.

23. A method as claimed in claim 18 wherein the antenna comprises a patch antenna disposed on a printed circuit board, the patch antenna comprising a rectangular antenna trace having two ends, two parasitic reflectors, and two gaps, and wherein each of the ends of the antenna trace is spaced from one of the parasitic reflectors by one of the gaps.

24. A method as claimed in claim 18 wherein the antenna comprises a fractal antenna disposed on a printed circuit board comprising an antenna trace electrically coupled to an adjacent ground plane.

25. A method as claimed in claim 24 wherein the ground plane comprises one or more pigtails extending therefrom.

26. A method as claimed in claim 25 wherein the ground plane is substantially rectangular and comprises two opposed side edges disposed between two opposed end edges, wherein a first pigtail extends from a first end of one of the end edges and a second pigtail extends from a second end of the one of the end edges, and wherein the first and second pigtails are of different lengths.
